(19) United States
(12) Patent Application Publication
(10) Pub. No.: US 2016/0214876 A1
(43) Pub. Date: Jul. 28, 2016

(54) WATER TREATMENT SYSTEMS AND METHODS FOR CONCURRENT REMOVAL OF VARIOUS TYPES OF ORGANIC MATERIALS

(71) Applicant: Glori Energy Inc., Houston, TX (US)

(72) Inventors: Brian G. Clement, Houston, TX (US); Eric Schackel, Pearland, TX (US)

(21) Appl. No.: 14/603,012

(22) Filed: Jan. 22, 2015

(51) Int. Cl. C02F 3/02; C02F 3/30; C02F 3/28

(52) U.S. Cl. CPC C02F 3/02; C02F 3/28; C02F 3/301; C02F 2101/32

(57) ABSTRACT

A water treatment method that concurrently subjects water to: (1) a biological water treatment process that removes a first set of organic materials from the water and (2) a physical water treatment process that removes a second set of organic materials from the water. A water treatment system that concurrently removes aqueous phase organic materials from water using a biological removal system that includes microorganisms and a physical separation system that includes sparging equipment for sparging the water to remove non-aqueous phase liquid organic materials, volatile phase organic materials.

### TECHNICAL FIELD

The present disclosure generally relates to the field of water treatment. More specifically the present disclosure relates to the removal of different types of organic materials from water.

### BACKGROUND

In various types of crude oil recovery operations, oil and other organic materials may contaminate water that has been used in the oil recovery operations or contaminate water that is in the surroundings of the location of the oil recovery operations. The water contaminants often include petroleum hydrocarbons, oilfield chemicals, various types of salts, suspended solids etc. While water contamination in oil recovery operations is commonplace, water discharged from those operations often has to meet stringent environmental standards. For example, in offshore oil recovery operations, water discharged into the sea has to meet certain minimum environmental standards. Because of the environmental standards, technologists have developed water treatment systems and processes for removing contaminants such as petroleum hydrocarbons and other organic materials from water.

Over time, different treatment systems that are applicable to different types of materials have been developed. For example, it is known that physical separation methods are commonly used to separate particulates/colloids from water. On the other hand, it is known that biological water treatment methods are used for the removal of soluble organic materials from water. The different types of methods are known to be implemented in series—one after the other. The biological water treatment is often implemented in bioreactors that use biofilm carriers. The conventional practice is to implement a physical separation process to remove oil and grease (free oil and grease) from the water prior to the biological water treatment process to remove soluble organic materials from the water. Water treatment systems that remove oil and grease from water by a physical water treatment process and then treat the water in a biological process are labor intensive and difficult to operate.

In an environment of increasingly stricter environmental standards, especially with the onset of hydraulic fracturing as a widely used oil recovery method and the continued development of microbial enhanced oil recovery (both of which use significant amounts of water), more effective water treatment processes are always desired.

### BRIEF SUMMARY

The present disclosure is directed to systems and methods for treating contaminated water so that the contaminated water is concurrently subjected to a physical water treatment process and a biological water treatment process. Applying both of these water treatment processes to contaminated water, at the same time, concurrently removes different types of organic material contaminants. The organic materials (e.g. organic compounds, hydrocarbons) may include materials such as aqueous phase organic materials, non-aqueous phase liquid organic materials and volatile phase organic materials. According to embodiments of the disclosure, one or more mechanisms that implement the biological water treatment process may be used, at the same time, to implement the physical water treatment process.

Embodiments of the invention include a water treatment method that involves concurrently subjecting water to a biological water treatment process that removes a first set of organic materials from the water (e.g. aqueous phase organic materials) and a physical water treatment process that removes a second set of organic materials from the water (e.g. non-aqueous phase liquid organic materials and volatile phase organic materials).

Embodiments of the invention also include a water treatment system having a gas floatation bioreactor vessel adapted to concurrently remove organic materials from water by a biological water treatment process and a physical separation process. The gas floatation bioreactor vessel includes a biological removal system having microorganisms for removing a first set of organic materials (e.g. aqueous phase organic materials) from the water and a physical separation system including sparging equipment for removing a second set of organic materials (e.g. non-aqueous phase liquid organic materials and volatile phase organic materials) from the water.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 illustrates a water treatment system according to embodiments of the invention;

FIG. 2 illustrates a process for treating water according to embodiments of the invention; and

FIG. 3 illustrates carriers used in the implementation of embodiments of the invention.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

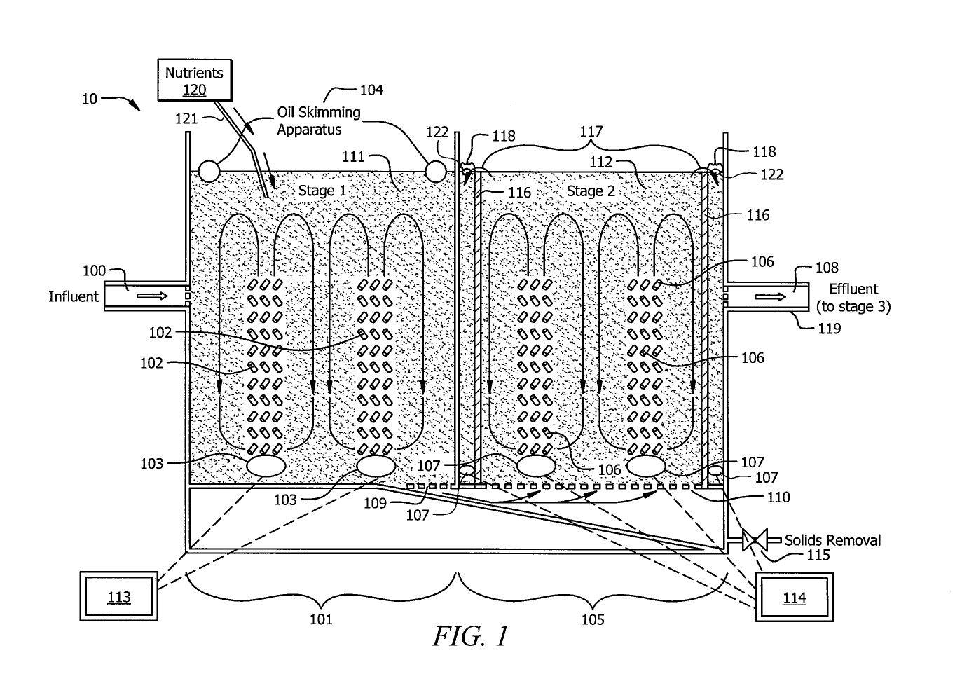

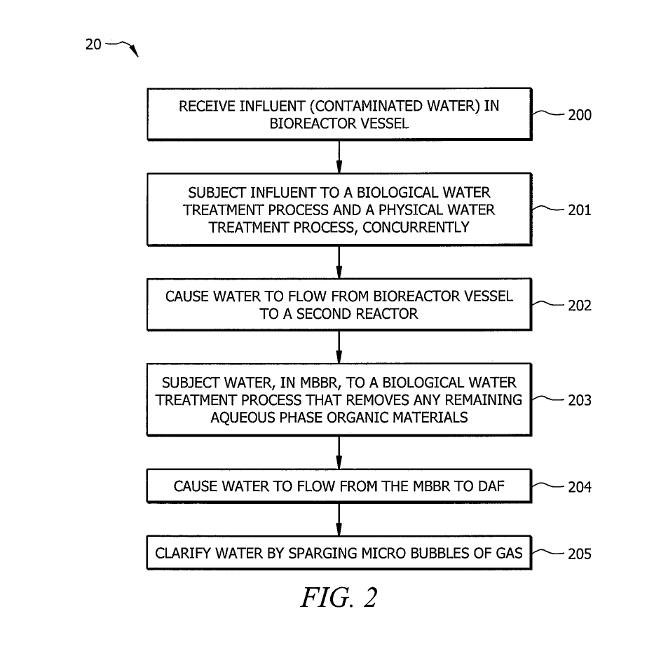

FIG. 1 shows water treatment system 10 for treating water, such as wastewater, according to embodiments of the invention. Wastewater may include water contaminated by materials such as petroleum hydrocarbons, oilfield chemicals, various types of salts, suspended solids etc. Water treatment system 10 treats water to simultaneously remove aqueous phase organic materials, non-aqueous phase liquid organic materials and volatile phase organic materials. FIG. 2 shows water treatment method 20, according to embodiments of the invention. Water treatment system 10 may be used to implement water treatment method 20 according to embodiments of the invention to treat water to meet one or more standards (e.g. environmental standards) established by a standards organization, government entity, company, etc.). Water treatment method 20 may begin, at block 200, with water treatment system 10 receiving influent 100 in gas floatation bioreactor vessel 101. Influent 100 may be a contaminated water stream containing any combination of materials such as one or more salts, free oil, aqueous phase organic materials (e.g. dissolved organic materials such as organic acids and alcohols), slightly dissolved non-aqueous phase liquid organic materials, and non-aqueous phase liquid organic materials (e.g. non-polar organic materials). Thus, influent 100 may have a broad spectrum of organic materials mixed with the water.

According to embodiments of the invention, after gas floatation bioreactor vessel 101 receives influent 100 (referred to as water 111 in gas floatation bioreactor vessel 101) at block 200, water treatment method 20 progresses, at block 201, into a first major stage in which water treatment system 10 simultaneously removes aqueous phase organic materials, non-aqueous phase liquid organic materials and volatile phase organic materials. The first major stage involves concurrently subjecting water 111, in gas floatation bioreactor vessel 101, to both of: (i) a biological water treatment process that removes the aqueous phase organic materials from water 111 and (ii) a physical water treatment process that removes non-aqueous phase liquid organic materials and volatile phase organic materials from water 111.

To implement the biological water treatment process, gas floatation bioreactor vessel 101 may have several biological carriers 102 circulating in it. Microorganisms colonize biological carriers 102. In other words, a biofilm forms on biological carriers 102. Essentially, biological carriers 102 act as a substrate on which microorganisms (a biomass) grows.

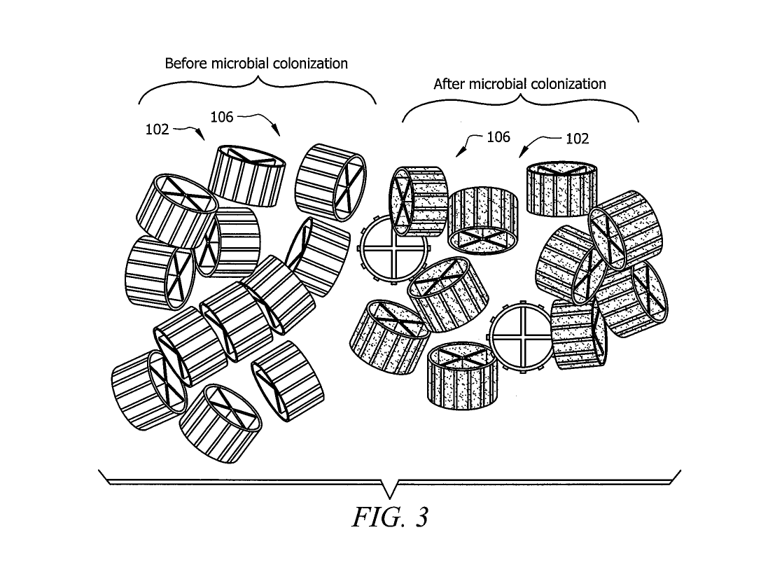

Biological carriers 102 may be made from polyethylene, polyurethane, plastic, granular activated carbon, sand, ceramic, limestone, graystone, slag, and combinations thereof. In embodiments, biological carriers 102 may float or partially float in water. Biological carriers 102 provide a large surface area for the microorganisms to live, grow, and degrade particular organic materials. To provide a large surface area, biological carriers 102 may be made with a basic cylindrical structure with additional structure (fins) within and on the outside of the cylindrical structure to provide additional surface area. FIG. 3 shows carriers used in the implementation of embodiments of the invention before microbial colonization and after microbial colonization of biological carriers 102 (and 106). The biological carriers shown in FIG. 3 may have a diameter of about 0.9-3 cm and height 0.4-1 cm.

The growth of biomass on biological carriers 102 may be allowed to occur naturally or particular microorganisms may be introduced in gas floatation bioreactor vessel 101 to colonize and form an initial biofilm on biological carriers 102. Methods for the establishment, development, and growth of biofilms are disclosed in “Successional development of biofilms in moving bed biofilm reactor (MBBR) systems treating municipal wastewater,” ENVIRONMENTAL BIOTECHNOLOGY, published online 10 Jul. 2013, the disclosure of which is incorporated herein by reference.

In embodiments of the invention, a gas flowing through water 111 circulates biological carriers 102 within water 111, as shown in FIG. 1. The gas may include natural air, nitrogen-enriched air, oxygen, argon, and combinations thereof. Gas supply equipment 113 may be a gas pump (blower), a compressor, a compressor pressurized tank etc. for supplying the gas so that it flows to gas floatation bioreactor vessel 101 via gas injection bars 103. As the gas flows in water 111, it circulates biological carriers 102, and, thereby, circulates the microorganisms on biological carriers 102. Thus, the flow of gas causes the microorganisms to circulate and come into contact with a large volume of water. In this way, the microorganisms are constantly being exposed to the organic materials in water 111. Thus, the microorganisms are able to consume or degrade organic materials such as aqueous phase organic materials and thereby remove such aqueous phase organic materials from water 111 in a biodegradation process.

According to embodiments of the invention, the flow of gas from gas injection bars 103 circulates microbe laden biological carriers 102 and thereby facilitates the biological water treatment process that biodegrades and removes aqueous phase organic materials. At the same time, the gas flowing from gas injection bars 103 facilitates the physical separation of non-aqueous phase liquid organic materials and volatile phase organic materials from water 111.

The biological degradation process and the physical separation process both involve several mechanisms that occur concurrently as a result of the gas being sparged (bubbled) through water 111. First, as mentioned earlier, bubbling of the gas through water 111 circulates biological carriers 102 in water 111 and thereby facilitates the exposure of microorganisms on biological carriers 102 to aqueous phase organic materials. Second, for embodiments that involve aerobic systems, the gas may include oxygen and that oxygen is delivered to the microorganisms that are growing on biological carriers 102. The aerobic microorganisms absorb and consume the oxygen in biochemical processes. Third, the bubbling of the gas through water 111 facilitates the evaporation of volatile phase organic materials (vapor stripping). In embodiments of the invention, gas floatation bioreactor vessel 101 may be closed so that such volatile organic materials that have been evaporated from water 111 may be stripped away from the head space above water 111 in gas floatation bioreactor vessel 101. Fourth, the bubbling of the gas through water 111 at a particular rate (e.g. a particular volume as a function of time) creates gas bubbles that cause at least some of the second set of organic materials, such as non-aqueous phase liquid organic materials, to coalesce, separate from water 111, and float atop water 111. Oil skimming apparatus (oil skimmer) 104 may then remove non-aqueous phase liquid organic materials. In embodiments of the invention, a determination is made as to the properties of the gas flow through water 111 that provides oxygen to the microorganisms at a pre-established rate, provides separation of non-aqueous phase liquid organic materials at a pre-established and vaporization of volatile phase organic materials at a pre-established rate.

In embodiments of the invention, the biological water treatment process may be unable to remove non-aqueous phase liquid organic materials and the volatile phase organic materials. Also, in embodiments of the invention, the physical water treatment process may be unable to remove the aqueous phase organic materials.

In embodiments of the invention, implementing water treatment method 20 using water treatment system 10 causes a microbial degradation process of both water phase organic materials and non-aqueous (oil phase) organic materials. And, at the same time, the physical water treatment process (sparging gas (bubbling gas) through water 111 via gas injection bars 103) drives organic materials, such as oil, up to the surface of water 111 where the oil coalesces, is skimmed, and removed from the reactor by oil skimming apparatus 104.

The biological water treatment process may involve: (i) introducing particular microorganisms to colonize biological carriers 102, (ii) introducing the appropriate amount and type of nutrients (e.g. amount of nitrogen and phosphorus) for the microorganisms and for the biological degradation desired (e.g. based on the type of organic materials to be degraded), (iii) maintaining the right temperature for the microorganisms to thrive, (iv) providing an appropriate amount of oxygen, and (v) combinations thereof. In embodiments of the invention, nutrient injector 121 may inject the appropriate nutrients from nutrient storage 120 into gas floatation bioreactor vessel 101. Once the right environment for growth of the microorganisms (microbes) have been established, and the appropriate flow rate of gas and gas bubble size is determined and provided, the removal of different types of organic materials from water 111 occurs at the same time.

Removing different types of organic materials—such as non-aqueous phase liquid organic materials (non-polar organic materials), vapor-phase organic materials, and aqueous phase organic materials—at the same time—provides for an efficient use of resources. Resources such as time, capital, and materials used in the water treatment process are more efficiently used in embodiments of the invention. For example, the systems and processes according to embodiments of the invention save time by providing a way to implement the biological water treatment process and the physical water treatment process concurrently instead of consecutively. In this way, water treatment method 20, for example, eliminates the time for either the biological or the physical water treatment process (i.e. the time for the shortest of the biological or the physical water treatment process may be eliminated). Indeed, to the extent that any organic materials in water 111 may be affected by both the biological water treatment process and the physical water treatment process, the systems and processes according to embodiments of the invention would be more effective than a system that has separate biological removal and physical removal processes. Thus, embodiments of the invention may include concurrently applying a biological water treatment process and a physical water treatment process to remove a particular organic material that can be removed by both processes.

Further, the systems and processes according to embodiments of the invention reduce the amount of capital required to invest in water treatment processes. For example, instead of requiring a first reactor vessel for the biological removal process and a second vessel for the physical removal process, embodiments of the invention use one vessel to implement both the biological water treatment process and the physical water treatment process.

Embodiments according to the invention also reduce the amount of material, such as gas, needed for the water treatment process. In a system with separate biological and physical water treatment processes, separate supplies of gas would be necessary—i.e. a larger volume of gas would be required as compared with the volume required for embodiments of the present invention. So embodiments of the invention provide a more efficient water treatment system from numerous perspectives.

In particular embodiments of the invention, instead of an aerobic process in gas floatation bioreactor vessel 101, an anaerobic process is implemented. In such embodiments, the gas may be a non-oxidizing gas (an inert gas) such as nitrogen or argon. In an anaerobic system, the microorganisms used to carry out the biological water treatment process are anaerobic and do not require oxygen. Thus, there is no need to add oxygen to gas floatation bioreactor vessel 101. However, appropriate nutrients (e.g. amount of nitrogen and phosphorus) may be added to gas floatation bioreactor vessel 101 to allow anaerobic growth of the microorganisms on biological carriers 102. These embodiments utilizing anaerobic biological activity to remove organic materials are capable of safely treating influent streams that have a high percentage of flammable material because the embodiments may use an inert gas to separate flammable material from water. The flammable material collects on top of water in bioreactor reactor vessel 101 and because an inert gas is used, there is a reduced risk of igniting the flammable material as compared to separation in an aerobic bioreactor, in which oxygen or air is circulated.

In block 201 of water treatment method 20, the biological water treatment process may include the removal of aqueous phase organic materials such as alcohols, aldehydes, amides, amines, carboxylic acids, ethers, esters, ketones, nitriles, nitro compounds and phenols by activity of microorganisms (microbes) that have colonized biological carriers 102 that are circulating in water 111. As described above, the gas injected in water 111, in gas floatation bioreactor vessel 101, may comprise air or oxygen so that any aerobic microorganisms on biological carriers 102 are provided with an appropriate amount of oxygen. The aerobic microorganisms consume the oxygen and degrade the organic materials.

In embodiments of the invention, for the biological water treatment process of block 201, the microorganisms that colonize biological carriers 102 and degrade aqueous phase organic materials may include microorganisms such as heterotrophic aerobic bacteria and archaea, heterotrophic nitrate-reducing bacteria, heterotrophic anaerobic bacteria and archaea, aerobic and anaerobic fungi, and combinations thereof.

In embodiments of the invention, the physical water treatment process of block 201 may include sparging a gas through water 111 and skimming non-aqueous phase liquid organic materials such as hydrocarbons with more than seven carbon atoms, aromatic compounds, asphaltenes, other components of underground hydrocarbon reservoirs, and combinations thereof from a surface of water 111. As noted above, the gas may be air, nitrogen enriched air, argon, and combinations thereof. In embodiments of the invention, sparging the gas through water 111 in gas floatation bioreactor vessel 101 provides enough oxygen to the microbes to stimulate aerobic microbial growth but not enough oxygen to cause the organic materials to ignite. In embodiments of the invention, the amount of oxygen that is sufficient to stimulate aerobic microbial growth of the microbes but is not sufficient to cause organic materials to ignite is in the range 0.5-1%. At block 201, the sparging of gas through water 111 may cause volatile phase organic materials to evaporate and thereby separate from water 111. If gas floatation bioreactor vessel 101 is a closed vessel, evaporated volatile phase organic materials collects above a surface of water 111, from where it may be suctioned out of and removed from gas floatation bioreactor vessel 101. These volatile phase organic materials may include materials such as low molecular weight hydrocarbons such as butane, benzene, hexane, propane, pentane, toluene, and combinations thereof.

According to embodiments of the invention, at block 202, water 111 flows from gas floatation bioreactor vessel 101 through screen 109 to reactor 105. Screen 109—located at the bottom of gas floatation bioreactor vessel 101—allows water 111 to underflow such that water 111 flows into reactor 105 (referred to as water 112 in reactor 105 (gas floatation bioreactor vessel's effluent water)). At the same time, screen 109 prevents biological carriers 102 from flowing from gas floatation bioreactor vessel 101 to reactor 105. Aqueous phase organic materials such as petroleum or components of petroleum that are not soluble in water 111 will likely have a lower density than the density of water 111 and so the petroleum or petroleum components will tend to move up in gas floatation bioreactor vessel 101 instead of down with the flow of water 111 into reactor 105. In reactor 105, water 112 will likely still have some organic materials remaining in it that needs to be biodegraded. Reactor 105 may have an inner concentric chamber that acts as a moving bed biofilm reactor (MBBR) 117 and an outer concentric chamber acting as dissolved air floatation (DAF) unit 118. Weir 116 separates moving bed biofilm reactor 117 from dissolved air floatation unit 118.

In reactor 105, block 203 implements a second major stage of water treatment method 20. Block 203 may involve subjecting water 112, in moving bed biofilm reactor 117, to a biological water treatment process that removes any remaining aqueous phase organic materials, from water 112. Essentially, the second major stage is a “clean-up” phase to remove the remaining dissolved organic materials.

To implement the biological water treatment process, moving bed biofilm reactor 117 may have several small carriers 106 in it so that microorganisms can colonize carriers 106. Like biological carriers 102, carriers 106 may be made from polyethylene, polyurethane, plastic, granular activated carbon, sand, ceramic, limestone, graystone, slag, and combinations thereof. Gas supply equipment 114 may be a gas pump (blower), a compressor, a compressor pressurized tank etc. for supplying the gas so that it flows to reactor 105 via gas injection bars 107. As the gas flows in water 112, it circulates biological carriers 106, and, thereby, circulates the microorganisms on biological carriers 106. Thus, the flow of gas causes the microorganisms to circulate and come into contact with a large volume of water. In this way, the microorganisms are constantly being exposed to the organic materials in water 112. Thus, the microorganisms are able to consume or degrade organic materials such as aqueous phase organic materials and thereby remove such aqueous phase organic materials from water 112 in a biodegradation process. The microorganisms that are used to carry out the biological water treatment process in reactor 105 may include: heterotrophic aerobic bacteria and archaea, heterotrophic nitrate-reducing bacteria, heterotrophic anaerobic bacteria and archaea, aerobic and anaerobic fungi, and combinations thereof.

Water treatment method 20 may also include allowing water 112 to flow from moving bed biofilm reactor 117 to dissolved air floatation unit 118 over weir 116, at block 204. At block 205, a flow of microbubbles through water 112 (MBBR's effluent water, in dissolved air floatation unit 118) clarifies water 112 so that any remaining material such as particulate matter (e.g. biomass) is brought to the surface of water 112. Surface skimming apparatus 122 may be used to skim such particulate matter from the surface of water 112. Also, coagulant may be added in dissolved air floatation unit 118 to cause the particulate matter to adhere together so that they can be more easily removed.

At block 205, bio-solids that have been created as a result of the biological water treatment processes in gas floatation bioreactor vessel 101 and reactor 105 are allowed to flow from reactor 105 through screen 110—located at the bottom of reactor 105—through valve 115 into a solids removal system. Outlet 119 provides an avenue to discharge water 112, as effluent 108, from dissolved air floatation unit 118 of reactor 105. Outlet 119 carries effluent 108 to a filtration system that removes any remaining bio-solids. The bio-solids (biomass) removal steps may include the use of flocculants.

It should be noted that, in embodiments of the invention, the order of the steps of water treatment method 20 may vary and some steps may not be carried out. For example, depending on the components of influent 100, the second major stage may not be necessary as all the removal of organic material may be achieved in gas floatation bioreactor vessel 101.

An embodiment of the invention is a water treatment method including concurrently subjecting water, in a vessel, to a biological water treatment process that removes aqueous phase organic materials from the water using microbes circulating in the water on carriers. The method may also include a physical water treatment process that removes non-aqueous phase liquid organic materials or volatile phase organic materials from the water. The physical water treatment process may include sparging a gas through the water. The sparging of the gas causes a coalescing of the non-aqueous phase liquid organic materials so that the non-aqueous phase liquid organic materials settles on a surface of the water or the sparging of the gas causing vapor stripping of the volatile phase organic materials so that the volatile phase organic materials move to a location above the surface of the water. In the water treatment method, the gas may be selected from the list consisting of: air, nitrogen-enriched air, nitrogen, oxygen, and combinations thereof. Also, the gas may include enough oxygen to stimulate aerobic microbial growth of the microbes but not enough oxygen to cause the organic materials to ignite.

Embodiments of the invention include methods of any combination of the following methods (a)-(t) and apparatus configured to carry out any combination of the following methods (a)-(t):

(a) A water treatment method including: concurrently subjecting water that includes organic materials therein, in a first vessel, to: a biological water treatment process that removes a first set of organic materials from the water; and a physical water treatment process that removes a second set of organic materials from the water.

(b) The water treatment method of (a) in which the first vessel comprises a gas floatation bioreactor vessel.

(c) The water treatment method of (a) in which the biological water treatment process includes: removing the first set of organic materials by microorganisms, the first set of organic materials comprise aqueous phase organic materials and the microorganisms are disposed on carriers circulating in the water.

(d) The water treatment method of (c) in which the carriers include material selected from the list consisting of: polyethylene, polyurethane, plastic, granular activated carbon, sand, ceramic, limestone, graystone, slag, and combinations thereof.

(e) The water treatment method of (c) in which the microorganisms are selected from the group consisting of: heterotrophic aerobic bacteria and archaea, heterotrophic nitrate-reducing bacteria, heterotrophic anaerobic bacteria and archaea, aerobic and anaerobic fungi, and combinations thereof.

(f) The water treatment method of (c) in which the physical water treatment process comprises sparging a first gas through the water, in which the sparging of the first gas causes a coalescing of non-aqueous phase liquid organic materials of the second set of organic materials so that the non-aqueous phase liquid organic materials settles on a surface of the water, wherein the sparging of the first gas causes the circulating of the carriers and the sparging of the first gas provides oxygen to the microorganisms in the biological water treatment process, and in which the aqueous phase organic materials and the non-aqueous phase liquid organic materials are removed concurrently from the water.

(g) The water treatment method of (f) in which the physical water treatment process further comprises: skimming the non-aqueous phase liquid organic materials from a surface of the water.

(h) The water treatment method of (c) wherein the physical water treatment process comprises sparging a first gas through the water, in which the sparging of the first gas causes vapor stripping of volatile phase organic materials of the second set of organic materials so that the volatile phase organic materials move to a location above the surface of the water, in which the sparging of the first gas causes the circulating of the carriers and the sparging of the first gas provides oxygen to the microorganisms in the biological treatment process, and in which the aqueous phase organic materials and the volatile phase organic materials are removed concurrently from the water.

(i) The water treatment method of (h) in which the physical water treatment process further comprises: removing the volatile phase organic materials from above a surface of the water.

(j) The water treatment method of (i) in which the first gas comprises enough oxygen to stimulate aerobic microbial growth of the microorganisms but not enough oxygen to cause the volatile phase organic materials to ignite.

(k) The water treatment method of (a) further including: receiving, in a second vessel, after the subjecting, the first vessel's effluent water; subjecting the first vessel's effluent water, in a first portion of the second vessel, to a second biological water treatment process that removes a third set of organic materials from the first vessel's effluent water; flowing the first portion's effluent water to a second portion of the second vessel; and subjecting the first portion's effluent water, in the second portion of the second vessel, to a second physical water treatment process that removes a fourth set of organic materials from the first portion's effluent water.

(l) The water treatment method of (k) wherein the second biological water treatment process includes: removing the third set of organic materials by microorganisms disposed on carriers circulating in the water in the first portion of the second vessel.

(m) The water treatment method of (1) wherein the microorganisms are selected from the group consisting of: heterotrophic aerobic bacteria and archaea, heterotrophic nitrate-reducing bacteria, heterotrophic anaerobic bacteria and archaea, aerobic and anaerobic fungi, and combinations thereof.

(n) The water treatment method of (l) wherein the second physical separation process includes: sparging a second gas through the first portion's effluent water in the second reactor vessel.

(o) The water treatment method of (n) wherein the second gas is selected from the list consisting of: air, nitrogen-enriched air, nitrogen, oxygen, and combinations thereof.

(p) The water treatment method of (k) in which the first portion of the second vessel includes a moving bed biofilm reactor and wherein the second portion of the second vessel includes a dissolved air floatation unit.

(q) The water treatment method of (k) in which the third set of organic materials comprise aqueous phase organic materials.

(r) The water treatment method of (k) wherein the fourth set of organic materials comprise biomass.

(s) The water treatment method of (r) further including: skimming particulate matter from a surface of the first portion's effluent water in the second vessel.

(t) The water treatment method of (a) for treating water to meet one or more standards.

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A water treatment method comprising:
introducing particular microorganisms into a first vessel to be disposed on carriers in the first vessel;
introducing nutrients into the first vessel for the microorganisms;
concurrently subjecting water that includes organic materials therein, in the first vessel, to:
a biological water treatment process that removes a first set of organic materials from the water, wherein the biological water treatment process comprises removing the first set of organic materials by the microorganisms, the first set of organic materials comprise aqueous phase organic materials, wherein the carriers are circulating in the water; and
a physical water treatment process that removes a second set of organic materials from the water.

2. The water treatment method of claim 1 wherein the first vessel comprises a gas floatation bioreactor vessel.

3. (canceled)

4. The water treatment method of claim 1 wherein the carriers comprise material selected from the list consisting of: polyethylene, polyurethane, plastic, granular activated carbon, sand, ceramic, limestone, graystone, slag, and combinations thereof.

5. The water treatment method of claim 1 wherein the microorganisms are selected from the group consisting of: heterotrophic aerobic bacteria and archaea, heterotrophic nitrate-reducing bacteria, heterotrophic anaerobic bacteria and archaea, aerobic and anaerobic fungi, and combinations thereof.

6. The water treatment method of claim 1 wherein the physical water treatment process comprises sparging a first gas through the water, wherein the sparging of the first gas causes a coalescing of non-aqueous phase liquid organic materials of the second set of organic materials so that the non-aqueous phase liquid organic materials settle on a surface of the water, wherein the sparging of the first gas causes the circulating of the carriers and the sparging of the first gas provides oxygen to the microorganisms in the biological water treatment process, and wherein the aqueous phase organic materials and the non-aqueous phase liquid organic materials are removed concurrently from the water.

7. The water treatment method of claim 6 wherein the physical water treatment process further comprises:
skimming the non-aqueous phase liquid organic materials from a surface of the water.

8. The water treatment method of claim 1 wherein the physical water treatment process comprises sparging a first gas through the water, wherein the sparging of a first gas causes vapor stripping of volatile phase organic materials of the second set of organic materials so that the volatile phase organic materials move to a location above the surface of the water, wherein the sparging of the first gas causes the circulating of the carriers and the sparging of the first gas provides oxygen to the microorganisms in the biological treatment process, and wherein the aqueous phase organic materials and the volatile phase organic materials are removed concurrently from the water.

9. The water treatment method of claim 8 wherein the physical water treatment process further comprises:
removing the volatile phase organic materials from above a surface of the water.

10. The water treatment method of claim 9 wherein the first gas comprises enough oxygen to stimulate aerobic microbial growth of the microorganisms but not enough oxygen to cause the volatile phase organic materials to ignite.

11. The water treatment method of claim 1 further comprising:
receiving, in a second vessel, after the subjecting, the first vessel's effluent water;
subjecting the first vessel's effluent water, in a first portion of the second vessel, to a second biological water treatment process that removes a third set of organic materials from the first vessel's effluent water;
flowing the first portion's effluent water to a second portion of the second vessel; and
subjecting the first portion's effluent water, in the second portion of the second vessel, to a second physical water treatment process that removes a fourth set of organic materials from the first portion's effluent water.

12. The water treatment method of claim 11 wherein the second biological water treatment process comprises:
removing the third set of organic materials by microorganisms disposed on carriers circulating in the water in the first portion of the second vessel.

13. The water treatment method of claim 12 wherein the microorganisms are selected from the group consisting of: heterotrophic aerobic bacteria and archaea, heterotrophic nitrate-reducing bacteria, heterotrophic anaerobic bacteria and archaea, aerobic and anaerobic fungi, and combinations thereof.

14. The water treatment method of claim 11 wherein the second physical water treatment process comprises:
sparging a second gas through the first portion's effluent water in the second vessel.

15. The water treatment method of claim 14 wherein the second gas is selected from the list consisting of air, nitrogen-enriched air, nitrogen, oxygen, and combinations thereof.

16. The water treatment method of claim 11 wherein the first portion of the second vessel comprises a moving bed biofilm reactor and wherein the second portion of the second vessel comprises a dissolved air floatation unit, wherein the dissolved air floatation unit is adapted to remove particulate matter from effluent of the moving bed biofilm reactor, wherein the particulate matter includes biomass.

17. The water treatment method of claim 16 wherein the third set of organic materials comprises aqueous phase organic materials.

18. The water treatment method of claim 11 wherein the fourth set of organic materials comprises biomass.

19. The water treatment method of claim 11 further comprising:
skimming particulate matter from a surface of the first portion's effluent water in the second vessel.

20. A water treatment method comprising:
introducing particular microorganisms into a first vessel to be disposed on carriers in the first vessel;
introducing nutrients into the first vessel for the microorganisms;
concurrently subjecting water that includes organic materials therein, in a vessel, to:
a biological water treatment process that removes aqueous phase organic materials from the water using microorganisms circulating in the water on carriers; and
a physical water treatment process that removes non-aqueous phase liquid organic materials or volatile phase organic materials from the water, wherein the physical water treatment process comprises:
sparging a gas through the water, the sparging of the gas causing (a) a coalescing of the non-aqueous phase liquid organic materials so that the non-aqueous phase liquid organic materials settle on a surface of the water or (b) vapor stripping of the volatile phase organic materials so that the volatile phase organic materials move to a location above the surface of the water.

21. The water treatment method of claim 20 wherein the physical water treatment process further comprises:
skimming the non-aqueous phase liquid organic materials from a surface of the water or removing the volatile phase organic materials from above the surface of the water.

22. The water treatment method of claim 20 wherein the gas is selected from the list consisting of: air, nitrogen-enriched air, nitrogen, oxygen, and combinations thereof.

23. The water treatment method of claim 20 wherein the gas comprises enough oxygen to stimulate aerobic microbial growth of the microorganisms but not enough oxygen to cause the organic materials to ignite.

24. A water treatment system comprising:
a first vessel adapted to concurrently remove organic materials from water by (1) a first biological water treatment process and (2) a first physical separation process, the first vessel comprising:
a biological removal system comprising microorganisms for removing a first set of organic materials from the water; and
a physical separation system comprising sparging equipment for sparging the water to remove a second set of organic materials from the water.

25. The water treatment system of claim 24 wherein the first vessel comprises a gas floatation bioreactor vessel.

26. The water treatment system of claim 24 wherein the biological removal system comprises:
a first set of carriers colonized by the microorganisms.

27. The water treatment system of claim 26 wherein the first set of carriers comprise material selected from the list consisting of: polyethylene, polyurethane, plastic, granular activated carbon, sand, ceramic, limestone, graystone, slag, and combinations thereof.

28. The water treatment system of claim 26 wherein the microorganisms are selected from the group consisting of heterotrophic aerobic bacteria and archaea, heterotrophic nitrate-reducing bacteria, heterotrophic anaerobic bacteria and archaea, aerobic and anaerobic fungi, and combinations thereof.

29. The water treatment system of claim 24 wherein the physical separation system comprises:
a first injector pipe for sparging a first gas through the water;
a compressor for delivering the first gas to the first injector pipe; and
a skimmer adapted to skim at least some of the second set of organic materials from a surface of the water.

30. The water treatment system of claim 29 wherein the first gas is selected from the list consisting of: air, nitrogen-enriched air, nitrogen, oxygen, and combinations thereof.

31. The water treatment system of claim 29 wherein the first gas comprises enough oxygen to stimulate aerobic growth of the microorganisms but not enough oxygen to cause the organic materials to ignite.

32. The water treatment system of claim 24 wherein the first set of organic materials comprise aqueous phase organic materials.

33. The water treatment system of claim 24 wherein the second set of organic materials comprise a selection from the list consisting of: non-aqueous phase liquid organic materials, volatile phase organic materials, and combinations thereof.

34. The water treatment system of claim 24 further comprising:
a second vessel adapted to receive the first vessel's effluent water and to remove organic materials from the first vessel's effluent water by (a) a second biological water treatment process and (b) a second physical separation process, the second vessel comprising:
a second biological removal system for removing a third set of organic materials from the first vessel's effluent water; and
a second physical separation system for removing a fourth set of organic materials from the first vessel's effluent water.

35. The water treatment system of claim 34 wherein the second biological removal system comprises:
a second set of carriers colonized by microorganisms.

36. The water treatment system of claim 35 wherein the microorganisms are selected from the group consisting of: heterotrophic aerobic bacteria and archaea, heterotrophic nitrate-reducing bacteria, heterotrophic anaerobic bacteria and archaea, aerobic and anaerobic fungi, and combinations thereof.

37. The water treatment system of claim 34 wherein the second physical separation system comprises:
a second injector pipe for sparging a second gas through the water.

38. The water treatment system of claim 37 wherein the second gas is selected from the list consisting of air, nitrogen-enriched air, nitrogen, oxygen, and combinations thereof.

39. The water treatment system of claim 34 wherein the second vessel comprises inner and an outer concentric chambers, wherein the inner chamber comprises a moving bed biofilm reactor and wherein the outer chamber comprises a dissolved air floatation unit.

40. The water treatment system of claim 34 wherein the third set of organic materials comprises aqueous phase organics.

41. The water treatment system of claim 34 wherein the fourth set of organic materials comprises biomass.

42. The water treatment system of claim 34 wherein the fourth set of organic materials comprises biomass.

43. A water treatment system comprising:
a first vessel adapted to concurrently remove organic materials from water that includes the organic materials therein by (1) a first biological water treatment process and (2) a first physical separation process, the first vessel comprising:
means for biologically removing aqueous phase organic materials from the water; and
means for physically removing materials from the list consisting of non-aqueous phase liquid organic materials, volatile phase organic materials, and combinations thereof from the water.

44. The water treatment system of claim 43 wherein the means for biologically removing comprises:
means for providing a substrate on which microorganisms live and grow.

45. The water treatment system of claim 43 wherein the means for biologically removing comprises:
means for consuming the aqueous phase organic materials.

46. The water treatment system of claim 43 wherein the means for physically separating comprises:
means for sparging a first gas through the water;
means for delivering the first gas to the means for sparging; and
means for skimming the non-aqueous phase liquid organic materials from a surface of the water.

47. The water treatment method of claim 1, wherein the physical water treatment process comprises sparging a first gas through the water, wherein the sparging of a first gas causes vapor stripping of volatile phase organic materials of the second set of organic materials so that the volatile phase organic materials move to a location above the surface of the water, wherein the sparging of the first gas causes the circulating of the carriers and wherein the microorganisms are anaerobic and the first gas is a non-oxidizing gas, and wherein the aqueous phase organic materials and the volatile phase organic materials are removed concurrently from the water.

48. The water treatment method of claim 10, wherein the first gas has 0.5%-1% oxygen.
